(19) United States
(12) Patent Application Publication
(10) Pub. No.: US 2025/0280392 A1
(43) Pub. Date: Sep. 4, 2025

(54) TIMING ENHANCEMENT FOR INTER-UE COORDINATION SCHEME

(71) Applicant: Apple Inc., Cupertino, CA (US)

(72) Inventors: Chunxuan Ye, San Diego, CA (US); Wei Zeng, Saratoga, CA (US); Seyed Ali Akbar Fakoorian, San Diego, CA (US); Dawei Zhang, Saratoga, CA (US); Hong He, San Jose, CA (US); Zhibin Wu, Los Altos, CA (US); Yushu Zhang, Beijing (CN); Oghenekome Oteri, San Diego, CA (US); Weidong Yang, San Diego, CA (US); Haitong Sun, Cupertino, CA (US)

(21) Appl. No.: 18/859,003

(22) PCT Filed: Apr. 23, 2022
(86) PCT No.: PCT/CN2022/088643

§ 371 Date: Oct. 22, 2024

(51) Int. Cl. H04W 72/02; H04W 72/40

(52) U.S. Cl. CPC H04W 72/02; H04W 72/40

(57) ABSTRACT

Methods, systems, and computer-readable medium to perform operations for timing enhancements for inter-UE coordination (IUC). In one aspect, a method includes actions of receiving, by the UE, IUC information transmitted from another UE, determining, by the UE and based on a validity duration for each of the resources indicated in the IUC, a set of resources that are not outdated, and using, by the UE, the determined set of resources for resource selection.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

More recently, wireless communication networks have expanded network coverage by using user equipment (UEs) as relays. In particular, the relay UEs establish direct connections with other UEs in order to extent the network coverage to those UEs. The connection that a relay UE establishes with other UEs is referred to as a sidelink communication. Among other examples, the sidelink connection can be either a UE-to-network relay, where the relay UE connects a remote UE to the network, or a UE-to-UE relay, where the relay UE connects a first remote UE to a second remote UE.

### SUMMARY

The present disclosure describes methods, systems, apparatus, and computer programs for timing enhancements for inter-UE coordination (IUC).

According to one innovative aspect of the present disclosure, a method to be performed by user equipment (UE) for inter-UE coordination (IUC) is disclosed. In one aspect, the method can include receiving, by the UE, IUC information transmitted from another UE, determining, by the UE and based on a validity duration for each of the resources indicated in the IUC, a set of resources that are not outdated, and using, by the UE, the determined set of resources for resource selection.

Other aspects includes apparatuses, systems, and computer programs for performing the actions of the aforementioned method.

The innovative method can include other optional features. For example, in some implementations, the validity duration is determined, for each resource indicated in the IUC, based on a validity timer.

In some implementations, the validity timer starts at a reference time.

In some implementations, the method can further include determining that multiple transmissions of the IUC have occurred, and in response to determining that multiple transmissions of the IUC have occurred, using the first transmission slot as the reference time.

In some implementations, the method can further include determining that multiple transmissions of the IUC have occurred, and in response to determining that multiple transmission of the IUC have occurred, using the last transmission slot as the reference time.

In some implementations, the reference time is determined based on a reference slot location indicated in the IUC.

In some implementations, the IUC is received responsive to an explicit request.

In some implementations, the reference time is the start slot of a resource selection window location associated with the explicit request.

In some implementations, the reference time is the slot when explicit request for IUC is transmitted.

In some implementations, the method can further include determining that multiple explicit requests for IUC have occurred, and in response to determining that multiple explicit requests for IUC have occurred, using the first explicit request slot as the reference time.

In some implementations, the method can further include determining that multiple explicit requests for IUC have occurred, and in response to determining that multiple explicit requests for IUC have occurred, using the last explicit request slot as the reference time.

In some implementations, the validity duration is a pre-defined value. In some implementations, the predefined value is 8000 slots. In some implementations, the predefined value is 1000 ms. In some implementations, the pre-defined value is (pre) configured per resource pool.

In some implementations, the pre-defined value is configured by PC5-RRC.

In some implementations, the pre-defined value is determined by the UE.

In some implementations, the validity duration depends on data priority value.

In some implementations, the resources indicated by the IUC include preferred resources and non-preferred resources, and the validity duration for preferred resources is the same as the validity duration for non-preferred resources.

In some implementations, the resources indicated by the IUC include preferred resources and non-preferred resources, and the validity duration for preferred resources is the different than the validity duration for non-preferred resources.

According to another innovative aspect of the present disclosure, a method to be performed by user equipment (UE) for inter-UE coordination (IUC) is disclosed. In one aspect, the method can include receiving, by the UE, an explicit request for IUC, determining, by the UE, an IUC latency bound, determining, by the UE, the resource selection window (RSW) of IUC information transmission based on the determined IUC latency bound, and transmitting, by the UE, the IUC information on a resource in the RSW of IUC information transmission.

Other aspects includes apparatuses, systems, and computer programs for performing the actions of the aforementioned method.

The innovative method can include other optional features. For example, in some implementations, the explicit request indicates a reference slot of a resource selection window (RSW), an end slot of the RSW, or a reference slot and an end slot of the RSW.

In some implementations, the method can include determining that the latency bound is larger than an end slot of the RSW indicated in the explicit request, and based on determining that the latency bound is larger than the end slot of RSW indicated in the explicit request, determining that the latency bound is invalid. In such implementations, the method can include based on a determination that the latency bound is invalid, adjusting, by the UE, the latency bound to the end slot of the RSW.

In some implementations, the method can include determining that the latency bound is smaller than the start slot of RSW indicated in the explicit request, and based on determining that the latency bound is smaller than the start slot of RSW indicated in explicit request, determining that the latency bound is invalid. In such implementations, the method can include based on a determination that the latency bound is invalid, adjusting, by the UE, the latency bound to the start slot of the RSW.

In some implementations, the reference point for the latency bound is a slot of transmitting the explicit request.

In some implementations, the latency bound is measured as a period of time that has elapsed from a reference point.

In some implementations, a reference time for the latency bound is the start slot of the RSW indicated in the explicit request.

In some implementations, a duration for the latency bound is based at least in part on a static configured bound.

In some implementations, the value of the latency bound is no later than the end slot of the RSW and no earlier than the start slot of the RSW.

In some implementations, the container of the latency bound is (i) SCI format 2-C, (ii) MAC CE, or (iii) SCI format 2-C and MAC CE.

In some implementations, the format of the latency bound is direct frame number (DFN) and slot number.

In some implementations, the format of the latency bound is a slot offset after a start slot of a RSW.

In some implementations, a duration of the latency bond is based on a static configured bound, n+T1, and Tproc,

In some implementations, a duration of the latency bond is based max (n+T1, static configured bound).

In some implementations, the method can further include selecting a value for latency bound from either (i) a first dynamically indicated latency bound value or (ii) a second semi-statically configured latency bound value, wherein the smallest of the first value or the second value is selected as the value for the latency bound.

In some implementations, the first dynamically indicated latency bound value is determined based on the received explicit request.

In some implementations, the second semi-statically configured latency bound value is predetermined.

In some implementations, the method can further include selecting a value for latency bound from either (i) a first dynamically indicated latency bound value or (ii) a second semi-statically configured latency bound value, wherein the largest of the first value or the second value is selected as the value for the latency bound.

In some implementations, the first dynamically indicated latency bound value is determined based on the received explicit request.

In some implementations, the second semi-statically configured latency bound value is predetermined.

In some implementations, a value for the latency bound is determined by using a dynamically indicated value for latency bound obtained from the explicit request to overwrite the semi-statically configured latency bound value.

In some implementations, a resource selection window (RSW) for ICU information transmission is upper bounded by the IUC latency bound.

According to another innovative aspect of the present disclosure, a method to be performed by user equipment (UE) for inter-UE coordination (IUC) is disclosed. In one aspect, in the method can include sending, by the UE, an explicit request to another UE, determining, by the UE, an IUC latency bound, and monitoring, by the UE, inbound IUC information transmission within the determined IUC latency bound.

Other aspects includes apparatuses, systems, and computer programs for performing the actions of the aforementioned method.

The innovative method can include other optional features. For example, in some implementations, determining, by the UE, that the latency bound has expired, and based on determining, by the UE, that the latency bound has expired, terminating, by the UE, monitoring for inbound IUC information transmission.

In some implementations, the method can further include determining, by the UE, that the latency bound has not expired, and based on determining, by the UE, that the latency bound has not expired, continuing, by the UE, to monitor for inbound IUC transmission information.

In some implementations, a duration for the latency bound is based at least in part on a static configured bound.

In some implementations, the value of the latency bound is no later than the end slot of the RSW and no earlier than the start slot of the RSW.

In some implementations, the container of the latency bound is (i) SCI format 2-C, (ii) MAC CE, or (iii) SCI format 2-C and MAC CE.

In some implementations, the format of the latency bound is direct frame number (DFN) and slot number.

In some implementations, the format of the latency bound is a slot offset after a start slot of a RSW.

In some implementations, a duration of the latency bond is based on a static configured bound, n+T1, and Tproc,

In some implementations, a duration of the latency bound is based max (n+T1, static configured bound).

According to another innovative aspect of the present disclosure, a method to be performed by user equipment (UE) for inter-UE coordination (IUC) is disclosed. In one aspect, the method can include transmitting an explicit request for IUC to a second UE at slot n, and initializing a restriction timer that restricts transmission of subsequent explicit requests for IUC to the second UE until the restriction timer exceeds a predetermined threshold period of time.

Other aspects includes apparatuses, systems, and computer programs for performing the actions of the aforementioned method.

The innovative method can include other optional features. For example, in some implementations, the predetermined period of time is a number of slots after slot n.

In some implementations, the predetermined period of time is 50 slots after slot n.

In some implementations, the predetermined period of time is based on a latency bound of IUC information indicated in the first explicit request has become invalid.

In some implementations, the predetermined threshold period of time based on a determination that the UE receives IUC information transmission corresponding to the explicit request.

In some implementations, the predetermined threshold is determined based on one or more of (i) a predetermined number of slots after slot n, (ii) a latency bound of IUC information indicated in the first explicit request has become invalid, and (iii) a determination that the UE receives IUC information transmission corresponding to the explicit request.

In some implementations, the predetermined threshold is only exceeded after (i) a predetermined number of slots after slot n, (ii) after latency bound of IUC information indicated in the first explicit request has become invalid, and (iii) after the UE receives IUC information transmission corresponding to the explicit request.

In some implementations, the method can further include based on a determination that the restriction timer exceeds a predetermined threshold period of time, enabling the UE to transmit a subsequent explicit request for IUC to the second UE.

In some implementations, the method can further include based on a determination that the restriction timer does not exceed a predetermined threshold period of time, preventing the UE from transmitting an explicit request for IUC to the second UE.

These and other innovative aspects of the present disclosure are described in more detail herein in the detailed description, the accompanying drawings, and the claims.

### BRIEF DESCRIPTION OF THE FIGURES

FIG. 1 is a diagram of an example communication system.

FIG. 2 is a flow chart of an example of a process for using a validity duration to indicate whether resources indicated by IUC information transmission are outdated.

FIG. 3 is a timing diagram of a resource selection process for IUC information transmission responsive to an explicit request.

FIG. 4A is a flowchart of an example of a process for determination of a latency bound, by UE-A, that is used to establish a resources selection window (RSW) for IUC information transmission.

FIG. 4B is a flowchart of an example of a process for determination of a latency bound, by UE-B, that is used to establish a period of time UE-B can expect to receive IUC information transmission.

FIG. 5 is a flowchart of an example of a process for using timing restrictions on explicit requests made by UE-B to UE-A.

FIG. 6 is a block diagram of an example of user equipment (UE).

FIG. 7 is a block diagram of an example of an access node.

Like reference symbols in the various drawings indicate like elements.

### DETAILED DESCRIPTION

The present disclosure describes methods, systems, apparatus, and computer programs for timing enhancements for inter-UE coordination (IUC). Among other things, this disclosure describes methods for using a validity duration to indicate whether resources indicated by IUC information transmission are expired (or outdated), determination of a latency bound used to establish a resources selection window (RSW) for IUC information transmission, and timing restrictions on explicit requests made by UE-B to UE-A.

In present specification, UE-B is a UE that is requesting/receiving resources via IUC whereas UE-A is a UE transmitting IUC. While, in some instances, a UE may be explicitly labeled as UE-B or UE-A, whether a particular UE described by the present disclosure is a UE-B or UE-A can be determined based on the operations performed by that particular UE (i.e., whether the UE is requesting/receiving resources via IUC or whether the UE is transmitting IUC).

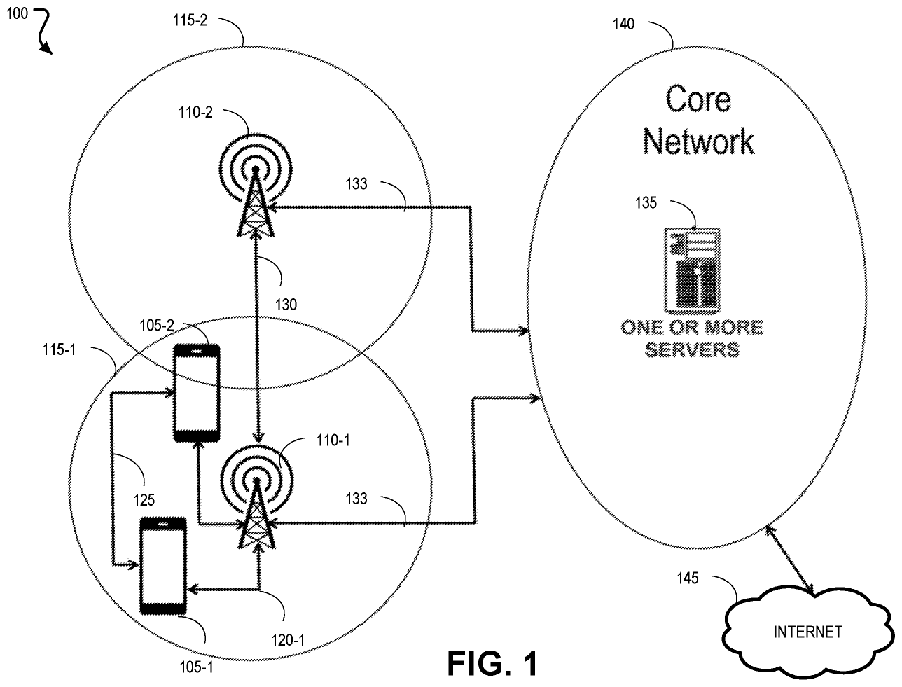

FIG. 1 illustrates an example communication system 100, according to some implementations. It is noted that the system of FIG. 1 is merely one example of a possible system, and that features of this disclosure may be implemented in other wireless communication systems.

The following description is provided for an example communication system 100 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. As used herein, the term “user devices” may refer generally to devices that are associated with mobile actors or traffic participants in the communication system 100, e.g., mobile (able-to-move) communication devices such as vehicles and pedestrian user equipment (PUE) devices. More specifically, the V2X communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

As shown, certain user devices may be able to conduct communications with one another directly, i.e., without an intermediary infrastructure device such as base station 110-1. As shown, UE 105-1 may conduct communications (e.g., V2X-related communications) directly with UE 105-2. Similarly, the UE 105-2 may conduct communications directly with UE 105-2. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 105 may be physical hardware devices capable of running one or more applications, capable of accessing network services via one or more radio links 120 with a corresponding base station 110, and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs (not shown in FIG. 1) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1st SCI for the purpose of sensing and broadcast communication, and the 2nd SCI carrying the remaining information for data scheduling of unicast/groupcast data transmission.

In some implementations, the sidelink 125 is established through an initial beam pairing procedure. In this procedure, the UEs 105 identify (e.g., using a beam selection procedure) one or more potential beam pairs that could be used for the sidelink 125. A beam pair includes a transmitter beam from a transmitter UE (e.g., UE 105-1) to a receiver UE (e.g., UE 105-2) and a receiver beam from the receiver UE to the transmitter UE. In some examples, the UEs 105 rank the one or more potential beam pairs. Then, the UEs 105 select one of the one or more potential beam pairs for the sidelink 125, perhaps based on the ranking.

As stated, the air interface between two or more UEs 105 or between a UE 105 and a UE-type RSU (not shown in FIG. 1) may be referred to as a PC5 interface. To transmit/receive data to/from one or more eNBs 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105 may connect with base station 110-1 via link 120 and simultaneously connect with UE 105-2 via sidelink 125.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to perform sidelink beam failure recovery procedures. The V2X communication system 100 can enable or disable support of the sidelink beam failure recovery procedures in the UEs 105. More specifically, the V2X communication system 100 can enable or disable support per resource pool or per PC5-RRC configuration (which may depend on UE capability). In the sidelink beam failure recovery procedures, one of the UEs 105 is designated as a transmitter UE (e.g., UE 105-1) and the other UE is designated as a receiver UE (e.g., UE 105-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

### Validity Duration of Inter-UE Coordination (IUC)

In some implementations, a validity duration of IUC can be defined so that UE-B does not use outdated information indicated by IUC in its resource selection procedure. In such implementations, UE-B does not use the information in IUC any more after the validity duration. The validity duration of IUC may be applicable to either explicit request triggered IUC or condition triggered IUC, or both. Explicit request triggered IUC is an IUC information transmission that is initiated by request transmitted by UE-B to UE-A. A condition triggered IUC is an IUC information transmission that is initiated, independent of an explicit request and/or in the absence of an explicit request, by UE-A. For explicit request triggered IUC, the validity duration may be equal to the end slot of resource selection window location for either non-preferred resources or preferred resources or both, which are indicated in the explicit request.

### Validity Timer Starting Point For Non-Preferred Resources

In some implementations, the validity duration for a set of non-preferred resources can be determined using a validity timer. In some implementations, the validity timer can measure a time period based on an amount of time, slots, or both, that have elapsed since a starting point (e.g., a reference time, reference slot, etc.). In some implementations, the starting point is indicated in IUC information transmission. In some implementations, the validity timer can start at the reference time. In some implementations, the reference time can be the slot when IUC is received. In such implementations, if there are multiple (re) transmissions of IUC information, then either the first or the last (re) transmission slot is set as the reference slot.

In other implementations, the reference slot location can be indicated in IUC. Alternatively, the reference slot can be the start slot of the resource selection window (RSW) location as indicated in the explicit request. In other implementations, the reference slot can be the slot when explicit request for IUC is transmitted. In such implementations, if there are multiple (re) transmissions of explicit request, then either the first or the last (re) transmission slot is set as the reference slot.

### Validity Duration Values For Non-Preferred Resources

In some implementations, a validity duration for a set of non-preferred resources can be indicated in IUC information transmission. In some implementations, the validity duration can be implemented using a pre-defined value. In some implementations, the pre-defined value can be a number of slots such as, e.g., 8000 slots. In other implementations, the pre-defined value can be a predetermined time period such as, e.g., 1000 ms.

In some implementations, the pre-defined value of the validity duration for non-preferred resources can be (pre) configured per resource pool or configured by PC5-RRC. For example, the predefined value of the validity duration can be (pre) configured to be the same as the largest resource reservation period supported in the resource pool. Alternatively, the predefined value of the validity duration can be (pre) configured to be the same as the sensing window duration (i.e., sl-SensingWindowList-r16) configured in the resource pool. This can be, e.g., either 1100 ms or 100 m. Alternatively, the pre-defined value of the validity duration can be separately configured in the resource pool as validity duration of the IUC.

Alternatively, in some implementations, the validity duration value for non-preferred resources can be set by UE-B. In some implementations, the validity duration set by UE-B may depend on the data priority value. In such implementations, the smaller the data priority value, the larger the validity duration. Likewise, the larger the data priority value, the smaller the validity duration.

### Validity Duration Values For Preferred Resources

A validity duration for preferred resources may be the same or different from the validity duration for a set of non-preferred resources indicated in IUC information transmission. In some implementations, a resource pool configuration indicates whether the same or different validity durations are used for preferred resource set or non-preferred resource set.

If the validity duration value for preferred resources is different from that for non-preferred resources, the validity duration value for preferred resources may have the following options. In some implementations, the validity duration value for preferred resources can be implemented using a pre-defined value. For example, in some implementations, the pre-defined value can be set to, e.g., 100 ms.

In some implementations, the pre-defined value of the validity duration for preferred resources can be (pre) configured per the resource pool. In some implementations, the pre-defined value can be the same as the smallest resource reservation period supported in the resource pool. Alternatively, the pre-defined value of the validity duration can be separately configured in the resource pool as validity duration of IUC for preferred resource set.

In some implementations, the pre-defined value of the validity duration for preferred resources can be correlated configured with the validity duration of IUC for preferred resource set. In some implementations, for example, the pre-defined value can be delta duration reduced from the validity duration of IUC for non-preferred resource set. In some implementations, the delta duration is configured in the resource pool.

Alternatively, in some implementations, the validity duration value can be set by UE-B for preferred resources. In some implementations, for example, UE-B may set the validity duration based on the data priority value. In such implementations, the smaller the data priority value, the larger the validity duration. Likewise, the larger the data priority value, the smaller the validity duration.

### Validity Timer Starting Point For Preferred Resources

In some implementations, the validity duration for a set of preferred resources can be determined using a validity timer. In some implementations, the validity timer can measure a time period based on an amount of time, slots, or both, that have elapsed since a starting point (e.g., a reference time, reference slot, etc.). In some implementations, the starting point (e.g., reference time, reference slot, etc.) can be the slot when IUC is received. In some implementations, the reference slot location can be indicated in IUC information transmission. In some implementations, the start slot of the resource selection window location as indicated in the explicit request. In some implementations, the slot when explicit request for IUC information transmission is transmitted.

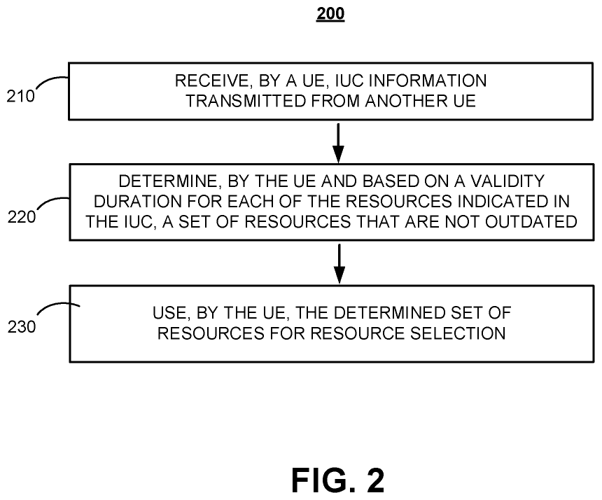

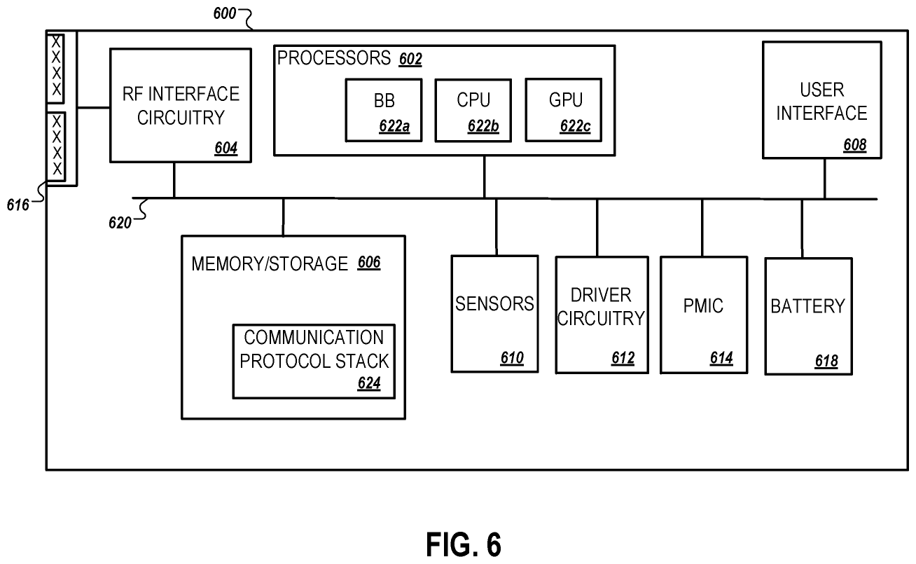

FIG. 2 is a flow chart of an example of a process 200 for using a validity duration to indicate whether resources indicated by IUC information transmission are outdated. The process 200 is described as being performed by a UE-B. A UE-B can have features of a UE such as, e.g., UE 600 described with reference to FIG. 6 below.

UE-B can begin performance of the process 200 by receiving IUC information transmitted from another UE (210). IUC information can include, e.g., information transmitted from another UE, e.g., a UE-A, to UE-B that indicates one or more resources that are available to UE-B for resource selection. The resources can include preferred resources or non-preferred resources. In some implementations, preferred resources may include whitelisted resources and non-preferred resources may include blacklisted resources. In other implementations, preferred resources may be resources that have a higher rating than non-preferred resources. In some implementations, the IUC is received, by UE-B, at stage 210 in response to an explicit request previously transmitted by UE-B to UE-A.

UE-B can determine based on a validity duration for each of the resources indicated in the IUC, a set of resources that are not outdated (220). In some implementations, the validity duration is determined, for each resource indicated in the IUC, based on a validity timer. The validity timer can be used to determine a validity duration based on (i) an elapsed period of time from a reference time or (ii) a predefined value.

In some implementations, the validity timer starts at a reference time. In some implementations, the reference time is determined based on a reference slot location indicated in the IUC. In some implementations, the reference time is the start slot of a resource selection window location associated with the explicit request. In some implementations, the reference time is the slot when explicit request for IUC is transmitted.

In other implementations, the validity duration is determined based on a pre-defined value. In some implementations, the predefined value is 8000 slots. In some implementations, the predefined value is 1000 ms. In some implementations, the pre-defined value is (pre) configured per resource pool. In some implementations, the pre-fined value is configured by PC5-RRC. In some implementations, the pre-defined value is determined by the UE. In other implementations, the validity duration depends on data priority value.

UE-B can use the set of resources determined at stage 220 for resource selection (230). In such implementations, this ensures that UE-B only uses resources that are not outdated or expired for resource selection.

In some implementations, the UE-B's execution of the process 200 can include determining that multiple transmissions of the IUC have occurred. Then, in response to determining that multiple transmissions of the IUC have occurred, the UE-B can use the first transmission slot as the reference time.

Alternatively, in other implementations, the UE-B's execution of the process 200 can include determining that multiple transmissions of the IUC have occurred. Then, in response to determining that multiple transmission of the IUC have occurred, the UE-B can use the last transmission slot as the reference time.

In some implementations, the UE-B's execution of the process 200 can include determining that multiple explicit requests for IUC have occurred. Then, in response to determining that multiple explicit requests for IUC have occurred, the UE-B can use the first explicit request slot as the reference time.

Alternatively, in other implementations, the UE-B's execution of the process 200 can include determining that multiple explicit requests for IUC have occurred. Then, in response to determining that multiple explicit requests for IUC have occurred, the UE-b can use the last explicit request slot as the reference time.

In some implementations, the resources indicated by the IUC include preferred resources and non-preferred resources. In such implementations, the validity duration for preferred resources can be the same as the validity duration for non-preferred resources. Alternatively, in other implementations, the validity duration for preferred resources can be different than the validity duration for non-preferred resources.

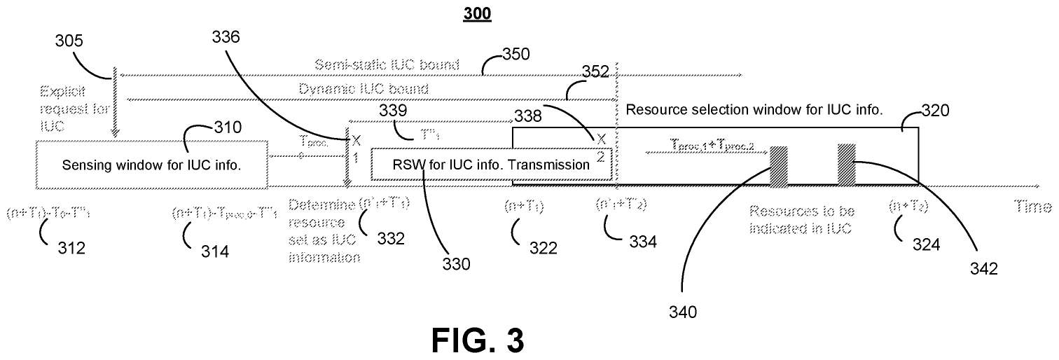

FIG. 3 is a timing diagram 300 of a resource selection process for IUC information transmission responsive to an explicit request. In this example, the timing diagram 300 describes a sequence of events that begins with a UE-B (not shown) submitting an explicit request 305 for IUC information to a UE-A (not shown). The explicit request 305 is received by UE-A and indicates a starting slot (n+T1) and an end slot (n+T2) of a first resource selection window 320 for IUC information, with (n+T1) and (n+T2) each representing one value of a frame and slot index. However, if IUC information is triggered by a condition other than explicit request 305 reception, then the starting slot (n+T1) and ending slot (n+T2) of the resource selection window for ICU information are determined by UE-A's implementation.

Upon receipt of the explicit request 305, UE-A performs sensing operations using the sensing window 310 for IUC information. During this time, UE-A determines the availability of resources 340, 342 within the first resource selection window 320 for IUC information defined by the explicit request 305. This processing time period that elapses while UE-A senses, or otherwise determines, resource availability within the first resource selection window 320 for IUC information is referred to as T_{proc,0}.

Parameters may be established for defining a sensing window 310 for inter-UE coordination (IUC) information for IUC scheme 1. The sensing window 310 for determining the set of resources for IUC information can be derived based on the starting slot (n+T₁) 322 and ending slot (n+T₂) 324 of the resources selection window 320 for IUC information that is used for determining the set of resources in TS38.214 section 8.1.4. In particular, the sensing window is defined by the range of slots [(n+T₁)−T₀−T″₁, (n+T₁)−T_{proc,0}−T″₁] as shown in 312, 314, T_{proc,0} is the sensing results processing time. In such implementations, T″₁ refers to a processing time of UE-A and is up to UE-A's implementation. In some implementations, T″₁ falls within the bounds of 0≤T″₁≤T_{proc,1}, where T_{proc,1} is UE-A's preparation time for PSCCH/PSSCH transmission.

Once the availability of resources 340, 342 within the resource selection window 320 for IUC information is determined, UE-A can use a resource selection window 330 for IUC information transmission in order to identify resources that can be used by UE-A to transmit IUC information indicating available resources 340, 342 within the first resource selection window 320 to UE-B. In order to identify resources that can be used by UE-A to transmit IUC information to UE-B, UE-A must determine the boundaries 332, 334 of the second resource selection window 330 for IUC information transmission.

The parameter (n′+T′₁) 332 is defined as a start slot of resource selection window 330 used for sidelink transmission carrying inter-UE coordination information. The parameter (n′+T′₂) 334 is defined as the end slot of resource selection window 330 used for sidelink transmission carrying inter-UE coordination information. In such implementations, the parameter n′ is the slot where UE procedure of determining TX resources of sidelink transmission carrying inter-UE coordination information is triggered.

For inter-UE coordination information triggered by UE-B's explicit request, multiple implementations were proposed by RAN1 #108. In particular a resource selection window (RSW) 330 for IUC information transmission can be defined as starting at a time X1 336 and ending at either X2 338 for explicit request or X3 (not shown in FIG. 3). In a first implementation, X1≤(n′+T′₁) and (n′+T′₂)≤X2. Alternatively, for inter-UE coordination information triggered by a condition other than explicit request reception, (n′+T′₂)<X3.

A mechanism referred to as a timer-based latency bound restriction can be used to restrict transmission of UE-A's IUC information. In some implementations, the latency bound for IUC was triggered by explicit request such as explicit request 305 and was statically configured in PC5-RRC. In such implementations, reference time of latency bound is the slot of transmitting explicit request. Transmission time of explicit request may have an arbitrary offset towards the resource selection window 320 indicated in IUC request message. However, this caused a problem because this semi-statically configured latency bound does not have dependency on the start of resource selection window of inter-UE coordination information indicated in the explicit request. The present disclosure provides a solution to this problem.

In some implementations, the IUC information will be cancelled if it exceeds the configured latency bound. In other implementations, UE-A collects sensing results for inter-UE coordination information generation until a point very close to the start of resource selection window of inter-UE coordination information.

### Latency Bound of IUC Information

### Semi-Statically Configured Latency Bound

According to one implementation of the present disclosure, a semi-statically configured latency bound 350 can be retained, but subject to a validity criteria. For example, in some implementations, the semi-statically configured latency bound 350 is invalid if it is larger than the end slot of RSW (i.e., n+T₂) indicated in explicit request. Alternatively, in other implementations, the semi-statically configured latency bound 350 is invalid if it is smaller than the start slot of RSW (i.e., n+T₁) indicated in explicit request. Note that, in some implementations, UE-A determines the set of preferred or non-preferred resources at slot (n+T₁−T′″₁). Alternatively, in some implementations, the UE-A can select the time value based on [static configured bound, n+T₁, Tproc], such as max (n+T₁, static configured bound). Alternatively, the reference time slot for the semi-statically configured latency bound 350 is (n+T₁), instead of the slot of explicit request transmission.

### Dynamic Latency Bound Inter-UE Coordination (IUC)

According to another implementation of the present disclosure, a latency bound 352 can be dynamically indicated in an explicit request from UE-B. In some implementations, the value of IUC latency bound is no larger than the end slot of RSW (i.e., n+T₂) 324 and no earlier than the start slot of RSW (i.e., n+T₁) 322.

Different types of containers can be used for IUC latency bounds. In some implementations, SCI Format 2-C can be used as a container for IUC latency bounds. In some implementations, MAC CE can be used as the container for IUC latency bound. In yet other implementations, both SCI Format 2-C and MAC CE can be used as containers for IUC latency bound.

Different types of formats can be used for IUC latency bound. For example, in some implementations, the form of DFN and slot number can be used as the format for IUC latency bound. By way of another example, in some implementations, the form of slot offset after the start slot of RSW (n+T₁) 322 can be used as the format for IUC latency bound.

Coexistence with Semi-Statically Configured IUC Latency Bound

In some implementations, the smaller value of IUC latency bound from dynamically indicated IUC latency bound or from semi-statically configured IUC latency bound is applied. Alternatively, in some implementations, the larger value of IUC latency bound from dynamically indicated IUC latency bound or from semi-statically configured IUC latency bound is applied. In some implementations, the dynamically indicated IUC latency value can be used to overwrite the semi-statically configured IUC latency bound.

In some implementations, the resource selection window (RSW) for IUC information transmission is upper bounded by the IUC latency bound. In some implementations, (n′+T₂′) 334 is upper bounded by the IUC latency bound, in additional to other upper bounds in Solution 1.

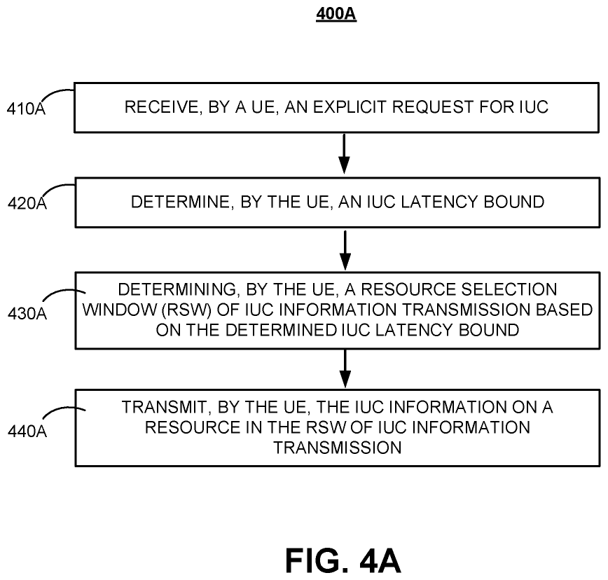

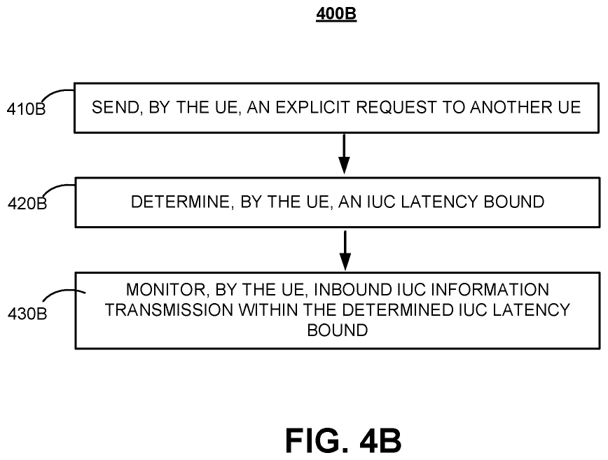

FIG. 4A is a flowchart of an example of a process 400A for determination of a latency bound, by UE-A, that is used to establish a resources selection window (RSW) for IUC information transmission. The process 400A is described as being performed by a UE-A. A UE-A can have features of a UE such as, e.g., UE 600 described with reference to FIG. 6 below.

UE-A can begin the process 400A by receiving an explicit request for IUC (410A). The explicit request can be transmitted to UE-A from a UE-B. UE-A can continue execution of the process 400A by determining an IUC latency bound (420A). In some implementations, a reference point for the latency bound is a slot of transmitting the explicit request. In some implementations, the explicit request indicates a reference slot of a resource selection window (RSW), an end slot of the RSW, or a reference slot and an end slot of the RSW.

UE-A can continue execution of the process 400A by determining a resource selection window (RSW) of IUC information transmission based on the determined IUC latency bound (430A). UE-A can continue execution of the process 400A by transmitting IUC information on a resource in the RSW of IUC information transmission (440A).

In some implementations, the UE-A's execution of the process 400A can include determining that the latency bound is larger than an end slot of the RSW indicated in the explicit request. Then, based on determining that the latency bound is larger than the end slot of RSW indicated in the explicit request, the UE-A can determine that the latency bound is invalid. In some implementations, based on a determination that the latency bound is invalid, the UE-A can adjust the latency bound to the end slot of the RSW.

In some implementations, the UE-A's execution of the process 400A can include determining that the latency bound is smaller than the start slot of RSW indicated in the explicit request. Then, based on determining that the latency bound is smaller than the start slot of RSW indicated in explicit request, the UE-A can determine that the latency bound is invalid. In some implementations, based on a determination that the latency bound is invalid, UE-A can adjust the latency bound to the starting slot of the RSW.

In some implementations, the latency bound is measured as a period of time that has elapsed from a reference point. In some implementations, the reference time for the latency bound is (n+T₁). In some implementations, a duration for the latency bound is based at least in part on a static configured bound. In some implementations, a duration of the latency bond is based on a static configured bound, n+T1, and Tproc, In some implementations, a duration of the latency bond is based max (n+T1, static configured bound). In some implementations, a value of the latency bound is no later than the end slot of the RSW and no earlier than the start slot of the RSW.

In some implementations, the UE-A's execution of the process 400A can include selecting a value for latency bound from either (i) a first dynamically indicated latency bound value or (ii) a second semi-statically configured latency bound value, wherein the smallest of the first value or the second value is selected as the value for the latency bound. Alternatively, in other implementations, the UE-A's execution of the process 400A can include selecting a value for latency bound from either (i) a first dynamically indicated latency bound value or (ii) a second semi-statically configured latency bound value, wherein the largest of the first value or the second value is selected as the value for the latency bound. The first dynamically indicated latency bound value can be determined based on the received explicit request. The second semi-statically configured latency bound value can be predetermined.

In some implementations, the value for the latency bound is determined by using a dynamically indicated value for latency bound obtained from the explicit request to overwrite the semi-statically configured latency bound value.

In some implementations, a resource selection window (RSW) for ICU information transmission is upper bounded by the IUC latency bound.

In some implementations, the latency bound may use a particular container and format. For example, in some implementations, a container of the latency bound is (i) SCI format 2-C, (ii) MAC CE, or (iii) SCI format 2-C and MAC CE. In some implementations, the format of the latency bound is direct frame number (DFN) and slot number. In other implementations, the format of the latency bound is a slot offset after a start slot of a RSW.

FIG. 4B is a flowchart of an example of a process for determination of a latency bound, by UE-B, that is used to establish a period of time UE-B can expect to receive IUC information transmission. The process 400B is described as being performed by a UE-B. A UE-B can have features of a UE such as, e.g., UE 600 described with reference to FIG. 6 below.

UE-B can begin execution of the process 400B by sending an explicit request to another UE (410B). UE-B can continue execution of the process 400B by determining an IUC latency bound (420B). UE-B can continue execution of the process 400B by monitoring inbound IUC information transmission within the determined IUC latency bound (430B).

In some implementations, the UE-B's execution of the process 400B can include determining that the latency bound has expired. Then, based on determining that the latency bound has expired, the UE-B can terminate monitoring for inbound IUC information transmission.

Alternatively, in some implementations, the UE-B's execution of the process 400B can include determining that the latency bound has not expired. Then, based on determining that the latency bond has not expired, the UE-B can continue to monitor for inbound IUC transmission information.

In some implementations, a duration for the latency bound is based at least in part on a static configured bound. In some implementations, the value of the latency bound is no later than the end slot of the RSW and no earlier than the start slot of the RSW. In some implementations, the container of the latency bound is (i) SCI format 2-C, (ii) MAC CE, or (iii) SCI format 2-C and MAC CE. In some implementations, the format of the latency bound is (DFN) and slot number. In other implementations, the format of the latency bound is a slot offset after a start slot of a RSW.

In some implementations, a duration of the latency bond is based on a static configured bound, n+T₁, and Tproc, In other implementations, a duration of the latency bond is based max (n+T₁, static configured bound).

### Time Restrictions on Explicit Request Transmissions

To avoid the ambiguity of the IUC information from the same UE-A, it can be beneficial to restrict the transmission of explicit request to the same UE-A. Despite the timing restriction, UE-B can still send explicit request to different UE-A(s), without timing restriction.

The timing restriction is used to establish a time gap between two consecutive explicit requests to the same UE-A. The time gap can be established in a number of different ways.

First, suppose the first explicit request is sent at slot n. In a first implementation, a timer (e.g., Y1 slots) is (pre) configured per resource pool, which serves the minimum time gap between two consecutive explicit requests to the same UE-A. In a second implementation, a second explicit request to the same UE-A can only be sent after the configured timer after slot n (i.e., after slot (n+Y1)). In a third implementations, a second explicit request can be sent to the same UE-A after the latency bound of IUC information indicated in the first explicit request (e.g., slot Y2). In a fourth implementations, a second explicit request can be sent to the same UE-A only after it receives the IUC corresponding to the first explicit request (e.g., slot Y3). In a fifth implementations, whether or not a UE-B can send a second explicit request to the same UE-A depends on (Y1, Y2, Y3). For example, the time gap can be a min {Y1, Y2, Y3} and a max {(n+Y1), Y3}.

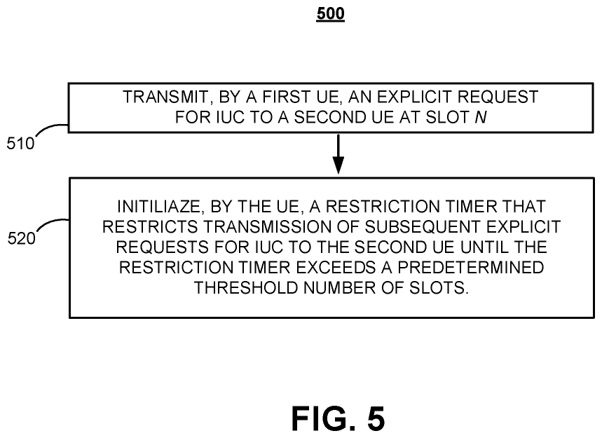

FIG. 5 is a flowchart of an example of a process 500 for using timing restrictions on explicit requests made by UE-B to UE-A. The process 500 is described as being performed by a UE-B. A UE-B can have features of a UE such as, e.g., UE 600 described with reference to FIG. 6 below.

UE-B can begin execution of the process 500 by transmitting an explicit request for IUC to a second UE at slot n (510). The UE-B can continue execution of the process 500 by initializing a restriction timer that restricts transmission of subsequent explicit requests for IUC to the second UE until the restriction timer exceeds a predetermined threshold period of time (520).

In some implementations, based on a determination that the restriction timer exceeds a predetermined threshold period of time, the UE-B's execution of process 500 can include enabling the UE to transmit a subsequent explicit request for IUC to the second UE.

In some implementations, based on a determination that the restriction timer does not exceed a predetermined threshold period of time, the UE-B's execution of the process 500 can include preventing the UE from transmitting an explicit request for IUC to the second UE.

The predetermined time period can be implemented in a variety of different ways to establish a time gap between successive explicit requests from a particular UE-B to the same UE-A. In some implementations, the predetermined period of time is a number of slots after slot n. the predetermined period of time is 50 slots after slot n. In other implementations, the predetermined period of time is based on a latency bound of IUC information indicated in the first explicit request has become invalid. In some implementations, the predetermined threshold period of time based on a determination that the UE receives IUC information transmission corresponding to the explicit request.

In some implementations, the predetermined threshold is determined based on one or more of (i) a predetermined number of slots after slot n, (ii) a latency bound of IUC information indicated in the first explicit request has become invalid, and (iii) a determination that the UE receives IUC information transmission corresponding to the explicit request.

In some implementations, the predetermined threshold is only exceeded after (i) a predetermined number of slots after slot n, (ii) after latency bound of IUC information indicated in the first explicit request has become invalid, and (iii) after the UE receives IUC information transmission corresponding to the explicit request.

FIG. 6 illustrates a UE 600, in accordance with some implementations. The UE 600 may be similar to and substantially interchangeable with UEs 105 of FIG. 1.

The UE 600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616.

In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600 including DRX as discussed herein. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

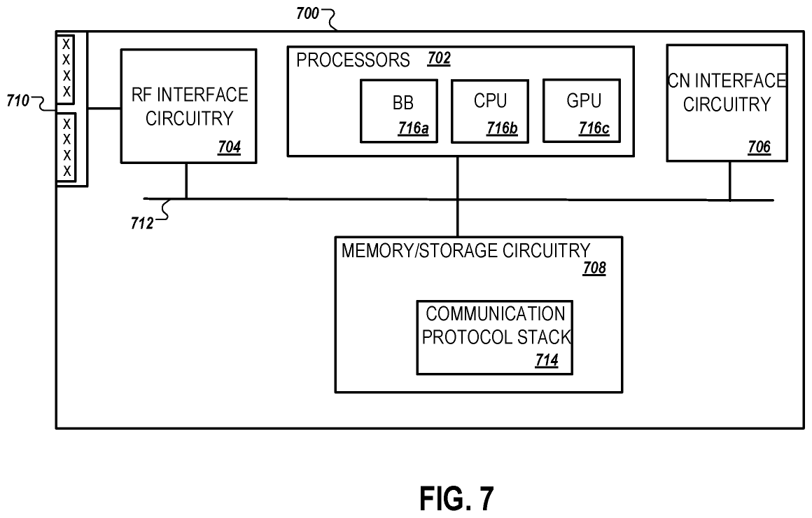

FIG. 7 illustrates an access node 700 (e.g., a base station or gNB), in accordance with some implementations. The access node 700 may be similar to and substantially interchangeable with base stations 110. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 700; a MAC/PHY split wherein RRC, PDCP, RLC, and MAC layers are operated by the CRAN/vBBUP and the PHY layer is operated by the access node 700; or a “lower PHY” split wherein RRC, PDCP, RLC, MAC layers and upper portions of the PHY layer are operated by the CRAN/vBBUP and lower portions of the PHY layer are operated by the access node 700.

In V2X scenarios, the access node 700 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-71. (canceled)

72. One or more processors configured to perform operations comprising:
receiving inter-user equipment (UE) coordination (IUC) information from another UE;
determining, based on a validity duration for each resource indicated by the IUC information, a set of resources that are not outdated; and
using the determined set of resources for resource selection.

73. The one or more processors of claim 72, wherein the validity duration is determined, for each resource indicated by the IUC, based on a validity timer.

74. The one or more processors of claim 73, wherein the validity timer starts at a reference time.

75. The one or more processors of claim 74, further comprising:
determining that multiple transmissions of the IUC have occurred; and
in response to determining that multiple transmissions of the IUC have occurred, using a first transmission slot as the reference time.

76. The one or more processors of claim 74, further comprising:
determining that multiple transmissions of the IUC information have occurred; and
in response to determining that multiple transmission of the IUC information have occurred, using a last transmission slot as the reference time.

77. The one or more processors of claim 74, wherein the reference time is determined based on a reference slot location indicated by the IUC information.

78. The one or more processors of claim 74, wherein the IUC information is received responsive to an explicit request from the other UE.

79. The one or more processors of claim 78, wherein the reference time is a start slot of a resource selection window location associated with the explicit request.

80. The one or more processors of claim 78, wherein the reference time is a slot in which the explicit request for IUC information is transmitted.

81. The one or more processors of claim 80, further comprising:
determining that multiple explicit requests for IUC information have occurred; and
in response to determining that multiple explicit requests for IUC information have occurred, using the slot as the reference time.

82. The one or more processors of claim 80, further comprising:
determining that multiple explicit requests for IUC information have occurred; and
in response to determining that multiple explicit requests for IUC information have occurred, using the slot as the reference time.

83. The one or more processors of claim 72, wherein the validity duration is a pre-defined value.

84. The one or more processors of claim 83, wherein the pre-defined value is 8000 slots or 1000 ms.

85. The one or more processors of claim 83, wherein the pre-defined value is (pre) configured per resource pool.

86. The one or more processors of claim 83, wherein the pre-defined value is configured by PC5-RRC or determined by the UE.

87. The one or more processors of claim 72, wherein the validity duration depends on data priority value.

88. The one or more processors of claim 72,
wherein the resources indicated by the IUC include preferred resources and non-preferred resources, and
wherein the validity duration for preferred resources is the same as the validity duration for non-preferred resources.

89. The one or more processors of claim 72,
wherein the resources indicated by the IUC information include preferred resources and non-preferred resources, and
wherein the validity duration for preferred resources is different than the validity duration for non-preferred resources.

90. A user equipment (UE) comprising:
one or more processors; and
one or more memory devices storing instructions that, when executed by the one or more processors, causes the UE to perform operations comprising:
receiving inter-user equipment (UE) coordination (IUC) information from another UE;
determining, based on a validity duration for each resource indicated by the IUC information, a set of resources that are not outdated; and
using the determined set of resources for resource selection.

91. A method comprising:
receiving inter-user equipment (UE) coordination (IUC) information from another UE;
determining, based on a validity duration for each resource indicated by the IUC information, a set of resources that are not outdated; and
using the determined set of resources for resource selection.
